(19) United States
(12) Patent Application Publication
(10) Pub. No.: US 2009/0215426 A1
(43) Pub. Date: Aug. 27, 2009

(54) PERSONAL SECURITY SYSTEM AND METHOD

(75) Inventor: Jerry Dimsdale, Oakland, CA (US)

Correspondence Address: SCHWEGMAN, LUNDBERG & WOESSNER, P.A., P.O. BOX 2938, MINNEAPOLIS, MN, 55402, US

(73) Assignee: Dimsdale Engineering, LLC, Oakland, CA (US)

(21) Appl. No.: 12/038,495

(22) Filed: Feb. 27, 2008

(51) Int. Cl. H04M 11/04

(52) U.S. Cl. 455/404.2; 455/404.1

(57) ABSTRACT

A personal security system and method includes a plurality of handsets communicating with one or more monitoring services, wherein each handset includes a sensor. Each handset is registered with the one or more monitoring services, wherein registering includes indicating the information to be sent to that monitoring service and the conditions under which the information is sent. An alert is generated at the handset and sensor information relevant to the alert is captured by a sensor in the handset. The alert and the captured sensor information are transmitted to one or more of the one or more monitoring services. The user then responds to a confirmation request received from one or more of the one or more monitoring services.

### BACKGROUND

1. Field of the Invention

The present invention is related to personal safety measures, and more particularly to a mobile device-based personal security system and method.

2. Background Information

Often, little time is available to react to a stressful and potentially dangerous situation. Any effective security system must be extremely simple to operate; the less thought and effort required to operate the system, the more likely it will be used effectively. Creating an alert to a remote location is an important first step in an emergency.

A U.S. Patent Application by Ghen Saito et al. (U.S. Patent Application No. 20070218895, published Sep. 20, 2007), describes a cellular telephone-based personal security system that allows users to create and erase security periods during which their location can be tracked. This leaves the responsibility for security service notification completely in the hands of the handset user.

Unfortunately, leaving the responsibility for security service notification completely in the hands of the handset user leads to false alarms. In a limited community environment (e.g., a small college campus) this may be acceptable, but in a more general environment, such false alarms can drive up the cost of providing the service.

What is needed is a personal security system and method that is less susceptible to user error and/or abuse.

### BRIEF DESCRIPTION OF THE DRAWINGS

FIG. 1 illustrates a personal security system;

FIG. 2 illustrates a personal security system handset;

FIG. 3 illustrates a method of handling an alert.

### DETAILED DESCRIPTION OF THE INVENTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

Mobile devices today often provide the capability to locate users, acquire and display still and video images, acquire and play audio, and communicate bidirectionally. Augmented simply, these capabilities can provide an extremely effective security system that provides user protection as well as remote situation assessment and criminal identification.

The data rate, accessibility, and reliability of mobile communication systems has risen dramatically. A mobile device can now, therefore, be used to create an effective personal security system. The features and effectiveness of the provided security will depend on the implemented features of the mobile device, and the capabilities and judgment of the security service monitoring the set of devices. In addition, it can be extremely helpful to provide and/or document comprehensive information about specific conditions relating to a perceived or real threat. In one embodiment, this information is evaluated at a remote location to assess the situation and determine what assistance might be required; it can be recorded and accessed at a later time to determine more exactly what transpired.

When activated, the security system can provide the exact location of a perceived threat, remote evidence of the severity and nature of the threat, and documentation of the activity that led to the alert.

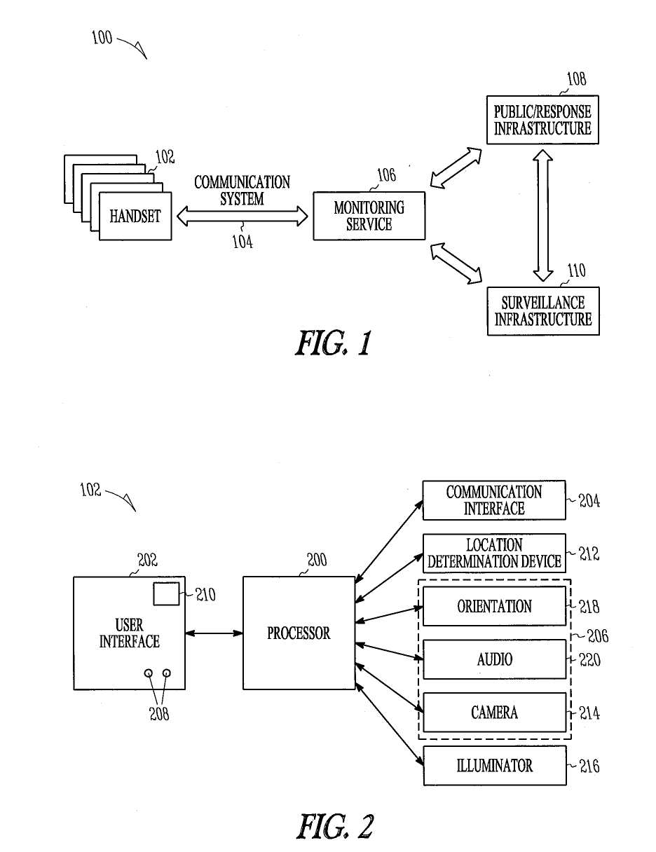

Referring to FIG. 1, the personal security system 100 includes at least one personal mobile handset 102 that communicates with a monitoring service 106 through a communication system 104. The communication system 104 can take any of a number of forms, though the most likely form will incorporate radio frequency communications. A convenient implementation of the system would use cell phone communications with handsets customized for the application. However, other private radio or optical infrastructure systems could also be employed.

Depending on the type of installation and the communication service, the monitoring service 106 could take many forms. In a typical implementation, the communication system 104 would include a cell phone and the monitoring service would include a private alarm monitoring service. In certain industrial or educational settings, the monitoring service 106 could be operated by the owner-operator.

In one embodiment, hybrid systems are implemented where the handsets communicate with a number of services 106, either in a sequential order that would maximize the likelihood that one of the services could be contacted or in parallel to provide the greatest response. In other embodiments, the service 106 contacted depends on the type of alert or is based on available information received from the handset. In some cases the monitoring service 106 will be operated by trained personnel, but in other cases its operation could be completely automated.

In one embodiment, when an alert is determined to be actionable by the monitoring service, notification will be given to a responsible agency 108. In many cases this could be public agencies, such as police, fire, or medical personnel. In other cases notification would be sent to specific individuals. When possible, these entities may consult a more extensive surveillance infrastructure 110, such as publicly or privately operated networks of cameras, microphones, or other sensors.

In one embodiment, the user initiates an alert. Handset 102 then goes through a predefined sequence of actions to create an alert condition. In one embodiment, the sequence of actions taken by the device to create an alert condition includes one or more of the following actions:
1. Send the location of the device to the security service;
2. Send the device orientation to the security service;
3. Transmit alert severity to the security service;
4. Continuously update the device location and/or orientation;
5. Take an image and transmit the image to the security service;
6. Periodically take and image and transmit it to the security service;
7. Start a video capture and continuously transmit it to the security service;
8. Acquire and transmit audio information to the security service.

In one embodiment, a monitoring service 106 responds to receipt of an alert by identifying the source of the alert, and recording some or all of the received information. Additionally, in one embodiment, the service reviews the received information and makes an independent assessment of the situation. In cases where there is an obvious threat or other information that the service provider assesses requires attention, relevant agencies 108 can be informed without any additional action required by the user.

In some areas cameras are permanently mounted for surveillance. Where possible, the location of an alert can be used to monitor specific permanent cameras. In instances where these cameras have remote pan and tilt capability, they can, for instance, be pointed at a specific area likely to enable observation of both the user generating the alert and any threat.

In cases where the communication is bidirectional, the monitoring service 106 can send a signal to the user's device asking for confirmation of the alert, particularly when the source of the alert is not obvious from other data. In one embodiment, confirmation might also include categorizing the alert into one of several types, such as 1) imminent personal threat of physical harm to the user; 2) imminent personal threat of physical harm to another person; or 3) imminent public threat, e.g. fire, accident, earthquake, structural collapse, etc.

In one embodiment, monitoring system 106 is configured to provide any of a number of default actions in case there is no timely confirmation. For instance, in one such embodiment, a default action is undertaken when the user does not respond or if communication system 104 is not responsive.

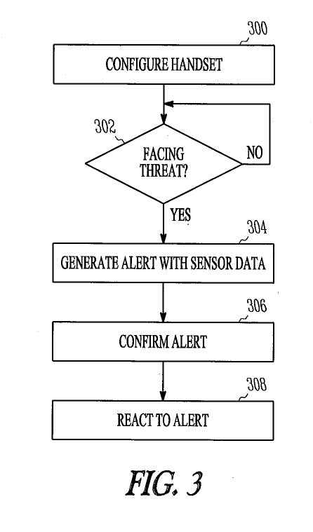

An example of a handset is shown in FIG. 2. Each handset 102 in FIG. 2 includes a processor 200 connected to a user interface 202 and a communication interface 204. In addition, each handset 102 includes one or more of a location determination device 212, which may be linked to or part of a communication interface 204, a system for sensing orientation 218, an audio transponder 220, usually consisting of a microphone and a speaker or buzzer, a camera 214 and an illuminator 216. In one embodiment, the audio transponder 220 includes a microphone and a speaker or buzzer.

In one embodiment, processor 200 controls the functions of the handset 102, interpreting operator requirements through the user interface 202, and coordinating the activities of communication interface 204 with sensors 206 within handset 102.

In one embodiment, communication interface 204 sends signals to either communication system 104 or to other handsets 102 directly. In operation, the user accesses the handset through user interface 202, which, in one embodiment, includes a set of physical or virtual buttons 208 and a visible display 210. The display may be as simple as a small set of light emitting diodes (LEDs), or may be capable of showing complicated graphics. In one embodiment, the display is touch sensitive, providing the equivalent of buttons 208 that are context sensitive and responsive to the processor 200. In one embodiment, in one mode of operation, handset 102 includes a single button 208 that can be actuated to initiate an alert.

A variety of sensors 206 can be used to aid the monitoring service 106 in responding to an alert. In one embodiment, sensors 206 include a camera 214. In one such embodiment, the camera records a single still image when an alert sequence is activated on the user interface. In another such embodiment, the camera records a series of still images when an alert sequence is activated on the user interface. In yet another such embodiment, the camera records a complete video sequence when an alert sequence is activated on the user interface.

In one embodiment, images are transmitted to the monitoring service 106 in near real time, so the recorded activities are not stored locally, but rather stored at the monitoring service. Currently, many cell phones already have the camera sensor. In those embodiments, the ability to transmit the images is added to the operating software. When the handset senses a low ambient light condition, it may also employ an illuminator 216 to assist in image acquisition.

In one embodiment, sensors 206 include an orientation sensor 218. The orientation of the handset can be used to determine the relative location from the handset of the activity that was perceived as a threat or alert situation. Orientation can then be used to efficiently activate or review data captured by a surveillance infrastructure 110. That is, one would only review sensors that were in a relevant position.

In one embodiment, sensors 206 include audio sensors 220. In many emergency situations, sounds can give good clues to the severity of the situation, and the intent of the participants. When an alert is activated, sounds can be acquired, transmitted to the monitoring service, recorded, and reviewed.

It can be very effective to combine information as to the location of the handset with sensor information when forming an alert message. Therefore, in some embodiments, handset 102 includes a location determination device 212 as shown in FIG. 2. There are many examples of location determination capabilities that would allow the handset to report its location or for the communication system as a whole to determine the location of a particular handset. Different examples of the security system make use of one or more types of location determination approaches. One type of location determination approach uses Global Positioning System (GPS) functionality that is built into the handset, optionally assisted by fixed elements of the mobile communication system in an Assisted GPS (AGPS) approach. One can also calculate location based on signal strength and/or direction (using, for instance, triangulation based on transmitted or received radio signals from the mobile communication system) or based on cell identification in a cellular telephone network. In one embodiment, handsets 104 send timed signals between themselves to determine the geometry of the handset constellation by measuring the time delay between the network. Different combinations of these techniques, and others known to people skilled in the art, can be used to determine the location of a particular handset.

Various approaches to configuring the handset to provide customized service are possible, including through provisioning by the operator of the mobile communication system and by downloading software to a configurable device. For example, the “home” or “dashboard” screen of a mobile telephone can provide direct “one touch” access to security services.

A method of using a handset 102 with one or more monitoring services 106 is described next and shown in FIG. 3.

First, at 300, the user configures the handset 102 to operate with each monitoring service 106, indicating the information to be sent to that monitoring service and the conditions under which the information is sent. In one embodiment, a first monitoring service 106 gets a single image and a location when an alert occurs. A second monitoring service 106 receives a predefined text message, and an audio clip. In one such embodiment, both monitoring services 106 are alerted simultaneously. In another embodiment, the second is alerted only if the first is inaccessible or unavailable.

Second, at 302, the user determines if he or she is facing an immediate threat. If so, at 304 the user points the camera 214 (or other applicable sensor) in their handset in the general direction of the activity causing concern and presses the configured alert button.

Third, at 306, one or more of the monitoring services receiving the alert reviews the information and either immediately forwards a notification based on its content, or signal the user's handset for confirmation. If the user cancels the alert, nothing further happens.

If the user's handset has become inaccessible or the user fails to respond, the monitoring service decides, at 308, whether to notify a security service based on the received information and the lack of contact.

If confirmation is received, the monitoring services act according to predefined criteria. This may involve further review of the situation based on accessible surveillance infrastructure, or contacting the appropriate security service.

The personal security system and method described above is less susceptible than others to operator error and/or abuse. In addition, the system and method provides the monitoring service far more information on which to make notification decisions. It also gives users the ability to provide protection not only for themselves but for others. Finally, there should be a higher level of deterrence, and less incentive to escalate the activity, as malefactors understand that evidence of their actions is being stored for use against them, especially in embodiments where the alerts are recorded in near real time in a remote location.

In the above systems, articles comprising computer readable medium are used to distribute computer code corresponding to parts of system 100. Examples of articles comprising computer readable media are floppy disks, hard drives, CD-ROM or DVD media or any other read-write or read-only memory device.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. A method of using a handset in a personal security system having a plurality of handsets communicating with one or more monitoring services, wherein each handset includes a sensor, the method comprising:
registering the handset with the one or more monitoring services, wherein registering includes indicating the information to be sent to that monitoring service and the conditions under which the information is sent;
generating an alert at the handset;
capturing sensor information relevant to the alert at the handset;
transmitting the alert and the captured sensor information to one or more of the one or more monitoring services; and
receiving and responding to a confirmation request from one or more of the one or more monitoring services.

2. The method according to claim 1, wherein capturing sensor information includes capturing an image with a camera.

3. The method according to claim 2, wherein generating an alert includes capturing location information and wherein transmitting the alert includes transmitting the captured location information.

4. The method according to claim 1, wherein capturing sensor information includes capturing audio information.

5. The method according to claim 1, wherein the handset includes a cellular telephone and wherein transmitting the alert and the captured sensor information includes transmitting the alert and the captured sensor information over a cellular network.

6. An article comprising a computer readable medium having instructions thereon, wherein the instructions, when executed in a handset, create a system for executing the method of claim 1.

7. A method of monitoring a first handset in a personal security system having a plurality of handsets communicating with one or more monitoring services, wherein each handset includes a sensor, the method comprising:
receiving, at a monitoring service, a message from the first handset indicating information to be sent from the first handset to the monitoring service and the conditions under which the information will be sent;
receiving an alert message from the first handset, wherein the alert message includes sensor information captured by the first handset, wherein the sensor information is relevant to an alert;
transmitting a confirmation request to the first handset; and
if the alert is confirmed, entering an alert condition relative to the first handset.

8. The method of claim 7, wherein the alert is confirmed if no response is received to the confirmation request.

9. The method of claim 7, wherein entering an alert condition relative to the first handset includes notifying other services of the alert.

10. An article comprising a computer readable medium having instructions thereon, wherein the instructions, when executed in a computer, create a system for executing the method of claim 7.

11. A personal security system, comprising:
a communication system;
one or more monitoring services; and
a plurality of handsets that communicate with the monitoring services using the communication system, wherein each handset includes a sensor and means, responsive to a user, for capturing sensor information when requested by the user and for communicating the captured sensor information to one or more of the one or more monitoring services in an alert message;
wherein the monitoring services that receive the alert message initiate emergency action in response to the alert message.

12. The system according to claim 11, wherein the means for capturing sensor information includes a camera.

13. The system according to claim 12, wherein each handset further includes a location determination device and wherein the alert message includes location information captured by the location determination device.

14. The system according to claim 11, wherein the means for capturing sensor information includes means for capturing audio information.

15. The system according to claim 11, wherein the communication system includes a cellular telephone network and wherein the emergency action includes calling the handset using the cellular telephone network.

16. A cellular telephone, comprising:
a cellular communication interface for communicating with a cellular network and with one or more monitoring services;
a sensor; and
an alert actuator, wherein the alert actuator, when activated, captures sensor information and communicates an alert message, via the cellular communication system, to one or more of the one or more monitoring services, wherein the alert message includes the captured sensor information.

17. The telephone according to claim 16, wherein the sensor includes a camera.

18. The telephone according to claim 17, wherein the camera includes a light for illuminating a scene.

19. The system according to claim 17, wherein each telephone further includes a location determination device and wherein the alert message further includes location information captured by the location determination device.

20. The telephone according to claim 16, wherein the sensor includes means for capturing audio information.

21. The telephone according to claim 16, wherein the sensor includes means for capturing orientation information.
